(19) United States
(12) Patent Application Publication
(10) Pub. No.: US 2004/0247957 A1
(43) Pub. Date: Dec. 9, 2004

(54) Hydrogen storage material and method for producing the same

(75) Inventors: Masaharu Hatano, Yokohama-shi (JP); Masashi Ito, Yokosuka-shi (JP); Junji Katamura, Yokohama-shi (JP); Mikio Kawai, Yokosuka-shi (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/853,651

(22) Filed: May 26, 2004

(30) Foreign Application Priority Data
Jun. 9, 2003 (JP) 2003-163905
Oct. 9, 2003 (JP) 2003-350487

(51) Int. Cl. H01M 8/06; H01B 1/24; C01B 31/04

(52) U.S. Cl. 429/19; 252/511; 423/448

(57) ABSTRACT

A hydrogen storage material of the present invention includes graphite formed of graphene, and has a characteristic feature such that the orientation of crystal planes of the graphene is disordered. Hence, hydrogen can be stored into a large number of gaps between the layers of graphene, and it is possible to realize a fuel cell vehicle capable of storing a sufficient amount of hydrogen to attain a long-distance drive.

### BACKGROUND OF THE INVENTION

1. Field of the Invention

The present invention relates to a hydrogen storage material, a hydrogen storage apparatus, a hydrogen storage system, a fuel cell vehicle, and a method for producing the hydrogen storage material, and more particularly to a graphite type hydrogen storage material.

2. Description of the Related Art

In recent years, as a clean energy source for solving global environmental problems that are becoming more serious, hydrogen has attracted attention, and techniques for production, storage, and utilization of hydrogen are actively developed. Especially in the current hydrogen storage systems using hydrogen storage materials, hydrogen storage alloys are considered to be the most promising materials that can be put into practical use in the near future.

However, LaNi5 type hydrogen storage alloys, which are most widely known as hydrogen storage materials, have a hydrogen storage capacity of 1.4% by weight at room temperature under a hydrogen pressure of 1 MPa. In addition, even vanadium type hydrogen storage alloys, which have recently attracted attention, have a hydrogen storage capacity of 2.4% by weight, and thus it is considered that the hydrogen storage capacity of the current hydrogen storage materials has not yet reached a practically acceptable level. Especially, the hydrogen storage alloys require the use of a rare metal at a high cost or a metal with high purity, causing the cost to further increase. For this reason, in the application to an automobile using a large amount of hydrogen, a hydrogen storage system using the hydrogen storage alloy has not been popular.

In contrast, carbon materials, which are expected to be promising hydrogen storage materials as well, have a hydrogen storage capacity per weight lower than that of the hydrogen storage alloys, but they need only a remarkably lower cost for materials. Especially, graphite type carbon materials require simple steps for production, as compared to those required for carbon nanotubes, and hence they are more easily manufactured on a commercial scale, and require a considerably low cost for production, and thus are promising materials. Various studies have been made on the usefulness of the graphite type carbon materials (see Japanese Patent Application Laid-open No. 2000-24495).

### SUMMARY OF THE INVENTION

However, as described in the above literature, pure graphite 31 shown in FIG. 1 is a crystal constituted by a number of layers of carbons bonded into a plane form (graphene), which are stacked on one another, and the gap between the stacked layers of carbons is as small as about 0.34 nm, and hence hydrogen cannot be held between the graphene layers. Therefore, graphite 31 holds hydrogen only on the outer surfaces, and has a disadvantage in that it cannot increase the hydrogen storage amount to a certain amount or larger.

Further, as stated in the above literature, the lower the temperature for hydrogen adsorption is, the larger the amount of hydrogen adsorbed on graphite becomes. However, when such graphite is applied to a hydrogen storage system, the system must be maintained at a low temperature, and therefore problems of the cost, weight, and operation properties are encountered. Thus, it is essential to obtain a hydrogen storage material which can be used without a low temperature system, and which secures a high hydrogen adsorption amount at around room temperature.

However, the hydrogen storage material reported in the above literature has the maximum hydrogen adsorption amount at room temperature (25° C.) as low as 0.8 cm³/g, i.e., 0.01% by weight or less, and poses a problem in that it cannot obtain a satisfactory hydrogen storage capacity.

The present invention was made in consideration of the above-described problems. It is a primary object of the present invention to provide a hydrogen storage material having a satisfactory hydrogen storage capacity so that the material can be mounted on a fuel cell vehicle at room temperature, and a method for producing a hydrogen storage material. In addition, it is another object of the present invention to provide a hydrogen storage apparatus and a hydrogen storage system as well as a fuel cell vehicle, using a hydrogen storage material having excellent hydrogen storage capacity.

The first aspect of the present invention provides a hydrogen storage material comprising graphite formed of graphene, wherein the orientation of crystal planes of the graphene is disordered.

The second aspect of the present invention provides a method for producing a hydrogen storage material comprising subjecting an organic polymer material to heat treatment, wherein the heat treatment is stopped when the orientation of crystal planes of graphene constituting the hydrogen storage material is disordered.

The third aspect of the present invention provides a hydrogen storage apparatus comprising a hydrogen storage material including graphite formed of graphene, wherein the orientation of crystal planes of the graphene is disordered.

The fourth aspect of the present invention provides a hydrogen storage system comprising a hydrogen storage apparatus including a hydrogen storage material having graphite formed of graphene, wherein the orientation of crystal planes of the graphene is disordered.

The fifth aspect of the present invention provides a fuel cell vehicle comprising a hydrogen storage system containing a hydrogen storage apparatus including a hydrogen storage material having graphite formed of graphene, wherein the orientation of crystal planes of the graphene is disordered.

### BRIEF DESCRIPTION OF THE DRAWINGS

The invention will now be described with reference to the-accompanying drawings wherein;

FIG. 1 is a schematic view showing a crystal structure of graphite;

FIG. 2 is a schematic view showing a structure of a hydrogen storage material of the present invention;

FIG. 3 is a perspective view showing an example of crystallite of the hydrogen storage material according to the present invention;

FIG. 4 is a cross-sectional view showing an embodiment of a hydrogen storage apparatus of the present invention;

FIG. 5 is a cross-sectional view showing an embodiment of a hydrogen storage system according to the present invention;

FIG. 6 is a side view showing an embodiment of a fuel cell vehicle according to the present invention;

FIG. 7 is a view showing the result of an XRD measurement with respect to the hydrogen storage material in Example 1;

FIG. 8 is a view showing the result of an XRD measurement with respect to the hydrogen storage material in Comparative Example 3; and

FIGS. 9, 10 and 11 are enlarged views of the hydrogen storage material in Example 6.

### DETAILED DESCRIPTION OF THE PREFERRED EMBODIMENTS

Preferred embodiments of a hydrogen storage material, a hydrogen storage apparatus, a hydrogen storage system, a fuel cell vehicle, and a method for producing the hydrogen storage material according to the present invention will be described below in detail.

(Hydrogen Storage Material)

The embodiment of the hydrogen storage material of the present invention will be described. The hydrogen storage material according to the present embodiment is formed of graphite and has a characteristic feature such that it is adjusted to be in a state in which crystallization of graphite is incomplete. In other words, it has a characteristic feature such that the orientation of crystal planes of graphene constituting graphite is disordered. Further, the hydrogen storage material is characterized in that a half peak width of a (002) diffraction peak is within a range from 6.50 to 8.62°, as measured by X-ray diffraction method using copper as a radiation source. It is more preferred that the half peak width of the (002) diffraction peak is within a range from 6.50 to 7.78°.

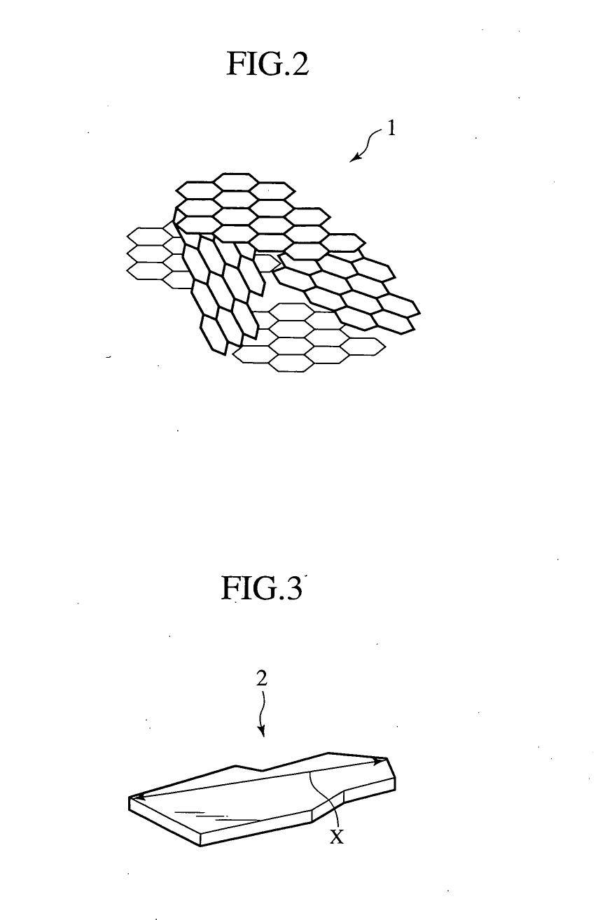

FIG. 2 schematically shows a hydrogen storage material 1 according to the present embodiment. The state in which crystallization of graphite is incomplete means a state such that, as shown in FIG. 2, growth of crystallization of carbon hexagonal networks in the horizontal direction does not proceed satisfactorily and hence a complete plane structure is not made, that is, the orientation of crystal planes of graphene does not face the fixed direction but is disordered. Formation of such hydrogen storage material 1 reduces the size of graphite crystallite, increasing the outer surfaces effective in hydrogen storage. Further, the outer surfaces are increased and the degree of disorder of graphite crystal is increased, so that gaps between the layers of graphene are not stable. For this reason, it is presumed that hydrogen can be stored into a large number of gaps between the layers of graphene.

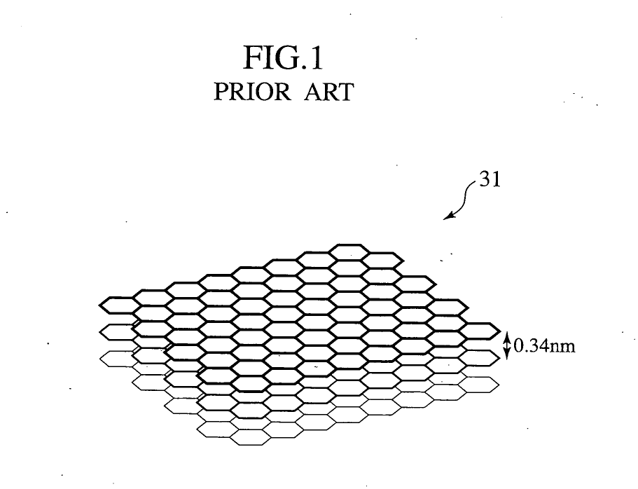

The stable gap between the layers of graphene is defined as one having a distance between the layers of about 0.34 nm in a graphite 31 as shown in FIG. 1. The disorder of graphite crystal is defined as small crystallite constituting a graphite structure, and the increase of the degree of disorder is defined as reduction of the size of crystallite.

The degree of disorder of crystal can be determined from the size of crystallite. The size of crystallite can be determined from the half peak width of a specific diffraction peak as measured by X-ray diffraction method (XRD). The larger the half peak width is, the smaller the size of crystallite becomes, or the larger the degree of disorder of the crystal becomes. When the crystal satisfactorily grows so that the half peak width becomes a predetermined value or smaller, a graphite structure having a distance between the layers of about 0.34 nm is formed in the crystal, so that the crystal is stabilized. In the stabilized graphite structure, the gaps for storage hydrogen disappear and hence, only a slight amount of hydrogen can be stored.

The form of the hydrogen storage material of the present embodiment may be a flake form. When the hydrogen storage material is in a flake form, a number of carbon hexagonal networks comprised of small crystallites are formed in the material, and hence the material has a larger number of spaces suitable for hydrogen storage. Therefore, the hydrogen storage material can store a large amount of hydrogen. In the present invention, the flake form means a flake-like thin plate form as shown in FIG. 3. With respect to the plane morphology of the flake form, there is no particular limitation, and examples include a circular form, an elliptic form, a rectangular form, and an indefinite form. The flake form may be partially or entirely bent or twisted as long as it has a substantial plate form.

It is preferred that the ratio of the maximum length in the top and back flat portions to the thickness of the hydrogen storage material in a flake form is within a range from 5 to 350. When the ratio is smaller than the lower limit of the range, for example, the orientation disadvantageously deteriorates, and, when the ratio is larger than the upper limit of the range, the packing density of the hydrogen storage material in a container is difficult to increase, leading to a problem of loading properties. The maximum length in the top and back flat portions means maximum crystal length X of crystallite in the plane direction as shown in FIG. 3.

(Method for Producing a Hydrogen Storage Material)

The embodiment of the method for producing a hydrogen storage material of the present invention will be described next. The method for producing a hydrogen storage material is a method which includes subjecting an organic polymer material to heat treatment, wherein the heat treatment is stopped when the orientation of crystal planes of graphene is disordered.

For rendering the orientation of crystal planes of graphene disordered, it is important that the temperature of the heat treatment for the organic polymer material is controlled, and therefore, in the method for producing a hydrogen storage material, it is preferred that the heat treatment is conducted at a temperature of 500 to 1000° C. When the heat treatment temperature is 1500° C. or higher, graphitization proceeds to an excess extent, so that the resultant hydrogen storage material exhibits only a very low hydrogen storage capacity. For the same reason, it is more preferred that the heat treatment be conducted in an inert gas.

Further, from the viewpoint of reducing the cost, it is desired that polyacrylonitrile (PAN) currently mainly used as a raw material for producing carbon fiber is used as the organic polymer material. For further increasing the hydrogen storage capacity, it is necessary that spaces suitable for storage of a larger amount of hydrogen be formed. When polyimide is used as a raw material, a large number of carbon hexagonal networks comprised of small crystallites can be formed to create a larger number of spaces suitable for hydrogen storage, so that the hydrogen storage capacity is more advantageously increased. However, in the present invention, the raw material is not limited to PAN or polyimide, and another organic polymer material, for example, mesophase pitch, rayon, polyvinyl alcohol, polyamide, phenol, polyvinyl chloride, polyvinylidene chloride, polybutadiene, polyacetylene, lignin, polyamideimide, aromatic polyamide, polyoxadiazole, or polybenzimidazole can be used.

When polyimide is used as the organic polymer material, it is desired to process the material into a thin film form. By processing the material into a thin film form, the spaces between the carbon hexagonal networks responsible for hydrogen storage can be efficiently formed. In such a case, a larger number of spaces suitable for hydrogen storage can be formed, thus increasing the hydrogen storage capacity. The organic polymer material in a thin film form has even more excellent orientation than that of the material in a powdery form or block form and hence, by processing the organic polymer material into a thin film form, a number of carbon hexagonal networks comprised of small crystallites are formed, and thus spaces suitable for storage of a larger amount of hydrogen are formed, increasing the hydrogen storage capacity. The hydrogen storage material prepared using a raw material in a thin film form maintains the thin film form even after being ground.

Further, when the form of the material is a thin film form, it is desired that the hydrogen storage material obtained is in a flake form and the ratio of the maximum length of the hydrogen storage material in a flake form to the thickness is within a range from 5 to 350. When the ratio is within this range, the above-mentioned effect is more remarkably exhibited, so that spaces suitable for storage of a larger amount of hydrogen can be formed, thus further increasing the hydrogen storage capacity.

(Hydrogen Storage Apparatus)

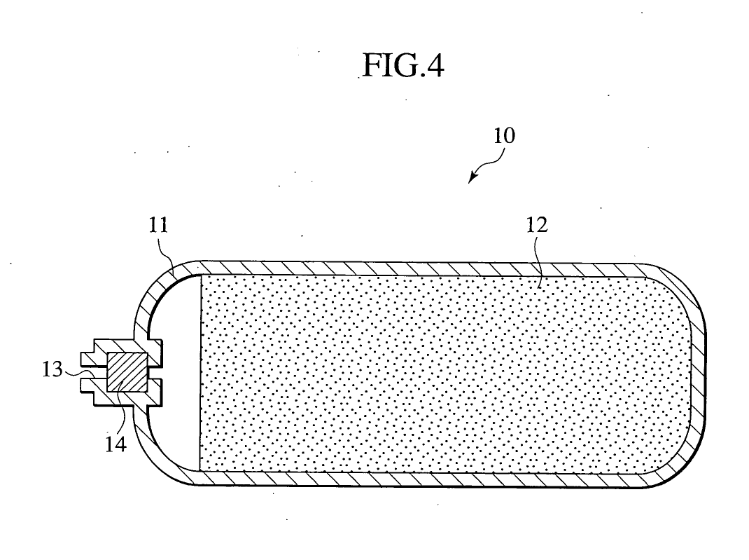

FIG. 4 shows an embodiment of a hydrogen storage apparatus for vehicle of the present invention. The hydrogen storage apparatus 10 has a high-pressure resistant container 11 packed with a hydrogen storage material 1 of the present invention. The hydrogen storage apparatus 10 is provided with a hydrogen outlet 13 through which hydrogen is fed or discharged, and the hydrogen outlet 13 is provided with a valve 14. The hydrogen storage apparatus 10 may either merely be packed with the hydrogen storage material 1 or use the material in the form of a solid appropriately formed by compression molding or a thin film.

The hydrogen storage apparatus 10 having the above structure can be used by mounting it on a vehicle so that it is incorporated into, for example, a fuel cell system or a hydrogen engine system. The form of the container may be a form having a simple closed space or a form having therein a rib or a column.

By having the above configuration, the hydrogen storage apparatus can be reduced in size and weight, and thus, when the apparatus is mounted on a vehicle, a large space is not needed for the apparatus in the vehicle, and the weight of the vehicle can be reduced.

(Hydrogen Storage System)

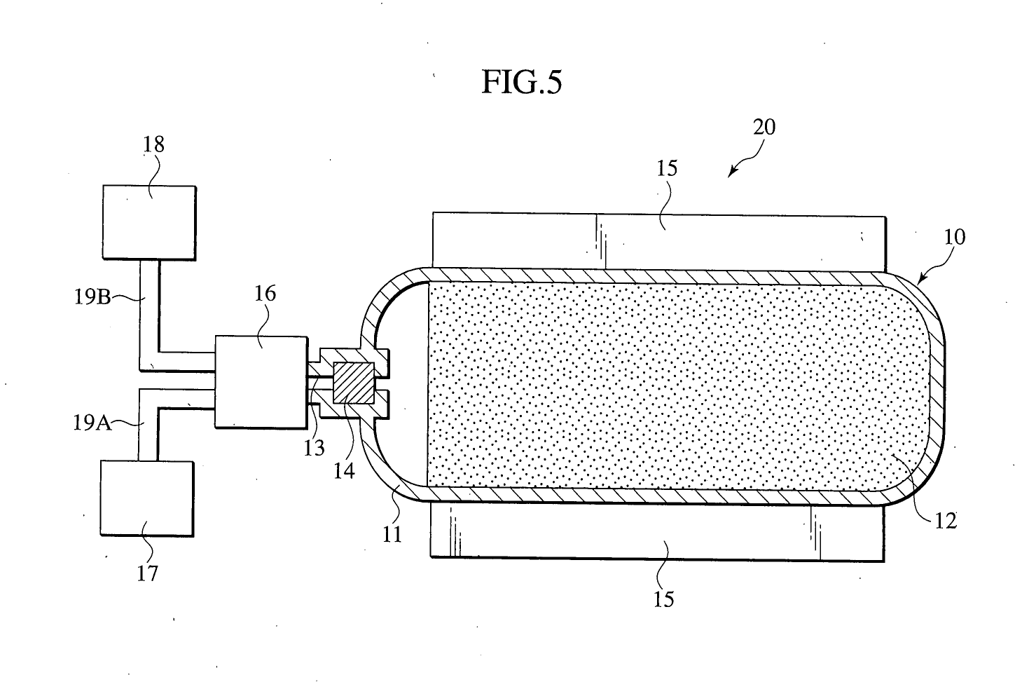

The configuration of hydrogen storage system 20 using the above-described hydrogen storage apparatus 10 is described with reference to FIG. 5.

As shown in FIG. 5, the hydrogen storage system 20 is equipped with a temperature controller 15 along the periphery of the high-pressure resistant container 11, for controlling the temperature of the hydrogen storage apparatus 10 at a predetermined temperature. A pressure regulator 16 is connected to the hydrogen outlet 13 of the hydrogen storage apparatus 10. Further, a hydrogen suction port 17 and a hydrogen discharge port 18 are connected to the pressure regulator 16 through, respectively, pipes 19A, 19B. In the hydrogen storage system 20 having the above structure, hydrogen is fed from the hydrogen suction port 17 through the pressure regulator 16 and valve 14 and stored in the hydrogen storage material 1 contained in the container 11. When hydrogen stored in the container 11 is taken out, the valve 14 and pressure regulator 16 control hydrogen to be introduced to the hydrogen discharge port 18 through the pipe 19B.

Thus, the use of the hydrogen storage apparatus 10 packed with the hydrogen storage material 1 of the present invention can realize the hydrogen storage system 20 having large hydrogen storage amount.

(Fuel Cell Vehicle)

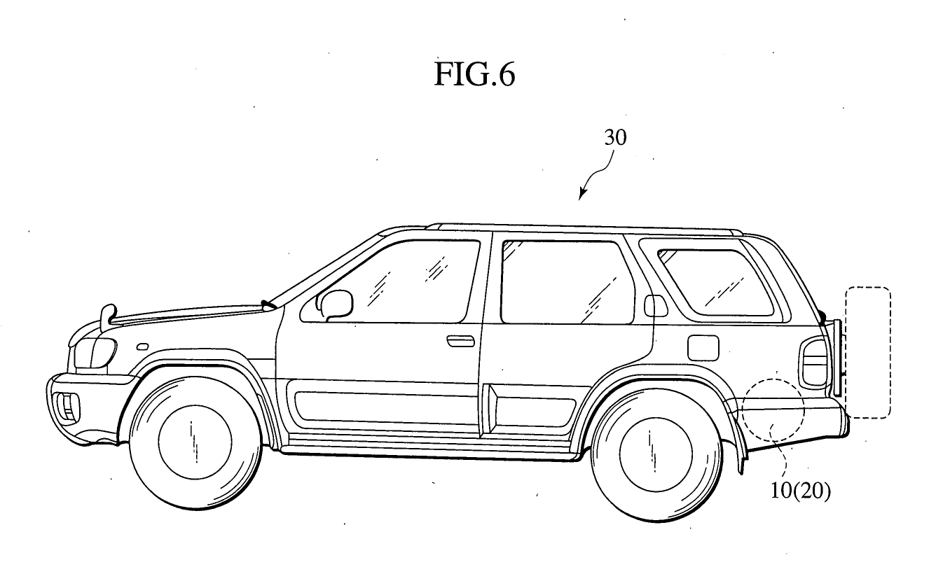

FIG. 6 shows an embodiment of a fuel cell vehicle having mounted the hydrogen storage apparatus 10 shown in FIG. 4 or the hydrogen storage system 20 shown in FIG. 5. In this case, the hydrogen storage apparatus 10 to be mounted on a vehicle may either be constituted by a single part or be divided into two or more, i.e., a plurality of parts, and a plurality of hydrogen storage apparatuses may individually have different forms. The hydrogen storage apparatus 10 can be installed inside the vehicle, for example, in an engine room or a trunk room, or on a floor portion under a sheet, or outside the vehicle, for example, on a roof portion. The fuel cell vehicle 30 having the above structure not only requires a reduced volume or weight of a fuel feeding portion and a lowered volume of a hydrogen storage system but also reduces the vehicle weight, thus making it possible to lower the fuel consumption rate. Therefore, there can be obtained effects such that the space in the vehicle can be more effectively utilized to improve the flexibility of the layout, and the running distance can be extended.

Hereinbelow, the hydrogen storage material of the present invention will be described with reference to the following Examples and Comparative Examples. In the following Examples, effectiveness of the hydrogen storage material of the present invention is examined, and there are shown examples of hydrogen storage materials formed from different raw materials by baking under different conditions.

### (EXAMPLE 1)

PAN powder was used as a raw material. PAN powder was placed in a crucible, and subjected to heat treatment in air at 300° C. for 1 hour. The resultant powder was then subjected to heat treatment in a stream of nitrogen gas at 900° C. for 2 hours. The resultant black mass was ground by a mortar to form a hydrogen storage material.

### (EXAMPLE 2)

PAN powder was placed in a crucible, and subjected to heat treatment in a stream of nitrogen gas at 900° C. for 2 hours. The resultant black mass was ground by a mortar to form a hydrogen storage material.

### (EXAMPLE 3)

PAN powder was placed in a crucible, and subjected to heat treatment in air at 300° C. for 1 hour. The resultant powder was- then subjected to heat treatment in a stream of nitrogen gas at 1000° C. for 2 hours. The resultant black mass was ground by a mortar to form a hydrogen storage material.

### (EXAMPLE 4)

PAN powder was placed in a crucible, and subjected to heat treatment in a stream of nitrogen gas at 700° C. for 2 hours. The resultant black mass was ground by a mortar to form a hydrogen storage material.

### (EXAMPLE 5)

PAN powder was placed in a crucible, and subjected to heat treatment in a stream of nitrogen gas at 500° C. for 2 hours. The resultant black mass was ground by a mortar to form a hydrogen storage material.

### (EXAMPLE 6)

Substantially the same procedure as in Example 1 was conducted, except that a polyimide film having a thickness of 25 μm was cut into thin film strips and used as a raw material, and the treated sample was ground by a mortar, to form a hydrogen storage material.

### (EXAMPLE 7)

Substantially the same procedure as in Example 6 was conducted, except that the temperature of the heat treatment under a stream of nitrogen gas was changed to 1000° C., to form a hydrogen storage material.

### (EXAMPLE 8)

Substantially the same procedure as in Example 6 was conducted, except that powdery polyimide (average particle size: 10 to 20 μm) was used as a raw material, and grinding by a mortar was not carried out, to form a hydrogen storage material.

### (EXAMPLE 9)

Substantially the same procedure as in Example 8 was conducted, except that the temperature of the heat treatment under a stream of nitrogen gas was changed to 950° C., to form a hydrogen storage material.

### (EXAMPLE 10)

Substantially the same procedure as in Example 6 was conducted, except that polyimide in a block form (φ15×20 mm column) was used as a raw material, to form a hydrogen storage material.

### (EXAMPLE 11)

Substantially the same procedure as in Example 7 was conducted, except that polyimide in a block form (φ15×20 mm column) was used as a raw material, to form a hydrogen storage material.

### (Comparative Example 1)

PAN powder was placed in a crucible, and subjected to heat treatment in air at 300° C. for 1 hour. The resultant powder was the subjected to heat treatment in a stream of nitrogen gas at 1500° C. for 2 hours. The resultant black mass was ground by a mortar to form a hydrogen storage material.

### (Comparative Example 2)

PAN powder was placed in a crucible, and subjected to heat treatment in air at 300° C. for 1 hour. The resultant powder was the subjected to heat treatment in a stream of nitrogen gas at 1700° C. for 2 hours. The resultant black mass was ground by a mortar to form a hydrogen storage material.

### (Comparative Example 3)

PAN powder was placed in a crucible, and subjected to heat treatment in air at 300° C. for 1 hour. The resultant powder was the subjected to heat treatment in a stream of nitrogen gas at 2300° C. for 2 hours. The resultant black mass was ground by a mortar to form a hydrogen storage material.

The hydrogen storage capacity and the half peak width were evaluated in accordance with the following methods. Examination of samples of the hydrogen storage materials was conducted using a microscope.

(Method for Evaluation of Hydrogen Storage Capacity)

The test for measurement of the hydrogen storage capacity was conducted in accordance with Japanese Industrial Standards (JIS) H7201. For surely obtaining the starting point at which the material stored no hydrogen, the measurement was conducted after evacuating at 300° C. for 1 hour to remove the residual gas. The measurement temperature was 30° C.

(Method for Evaluation of Half Peak Width)

The evaluation was conducted by X-ray diffraction method (hereinafter, referred to as “XRD”). In XRD, an X-ray diffractometer MXP18VAHF, manufactured by Bruker AXS K. K., was used. The measurement was conducted under conditions such that the radiation source was copper (Cu), the tube voltage was 940.4 kV, the tube current was 20.0 mA, the data range was 2.020 to 90.000 deg, the sampling interval was 0.020 deg, and the scanning speed was 4.000 deg/min.

The results of evaluations of the hydrogen storage capacity and half peak width in Examples 1 to 5 and Comparative Examples 1 to 3 are shown in Table 1 below.

TABLE 1

| | Hydrogen storage capacity | Half peak width |
|---|---|---|
| | (% by weight) | (°) |
| Example 1 | 0.498 | 7.78 |
| Example 2 | 0.471 | 7.30 |
| Example 3 | 0.475 | 6.77 |
| Example 4 | 0.273 | 7.89 |
| Example 5 | 0.187 | 8.62 |
| Comparative Example 1 | 0.1 or less | 5.07 |
| Comparative Example 2 | 0.1 or less | 1.22 |
| Comparative Example 3 | 0.1 or less | 0.32 |

Further, the results of evaluations of the hydrogen storage capacity and half peak width in Examples 6 to 11 are shown in Table 2 below.

TABLE 2

| | Hydrogen storage capacity | Half peak width |
|---|---|---|
| | (% by weight) | (°) |
| Example 6 | 0.601 | 6.95 |
| Example 7 | 0.528 | 6.50 |
| Example 8 | 0.476 | 7.02 |
| Example 9 | 0.442 | 6.89 |
| Example 10 | 0.490 | 7.06 |
| Example 11 | 0.464 | 6.98 |

As can be seen from the above results, in Examples 1 to 11, the hydrogen storage capacity is high, and the half peak width of the (002) diffraction peak falls within a range from 6.50 to 8.62°. Especially in Examples 1 to 3 and Examples 6 to 11, the hydrogen storage capacity is high, and the half peak width of the (002) diffraction peak in Examples 1 to 3 and Examples 6 to 11 is 6.50 to 7.78°. In Examples 6 and 7 in which the material is processed into thin film strips, the hydrogen storage capacity is especially high, indicating that the processing of the material into a thin film form makes it possible to form a number of carbon hexagonal networks comprised of small crystallites. It has been found that the hydrogen storage capacity is increased by this method. Further, from the fact that the hydrogen storage capacity in Example 6 is higher than that in Example 7, the hydrogen storage capacity in Example 8 is higher than that in Example 9, and the hydrogen storage capacity in Example 10 is higher than that in Example 1, it has been found that the hydrogen storage capacity becomes higher when the heat treatment in a stream of nitrogen gas is conducted at 900° C.

In contrast to the results of Examples 1 to 11, the hydrogen storage capacity in each of Comparative Examples 1 to 3 is 0.1% by weight or less, which is not a satisfactory hydrogen storage capacity. In addition, the half peak width of the (002) diffraction peak in each of Comparative Examples 1 to 3 is 0.32 to 5.07°, which falls outside of a range from 6.50 to 8.62° resulting in a high hydrogen storage capacity. From this result, it has been found that a high hydrogen storage capacity cannot be obtained when the heat treatment in a stream of nitrogen gas is conducted at 1500° C. or higher.

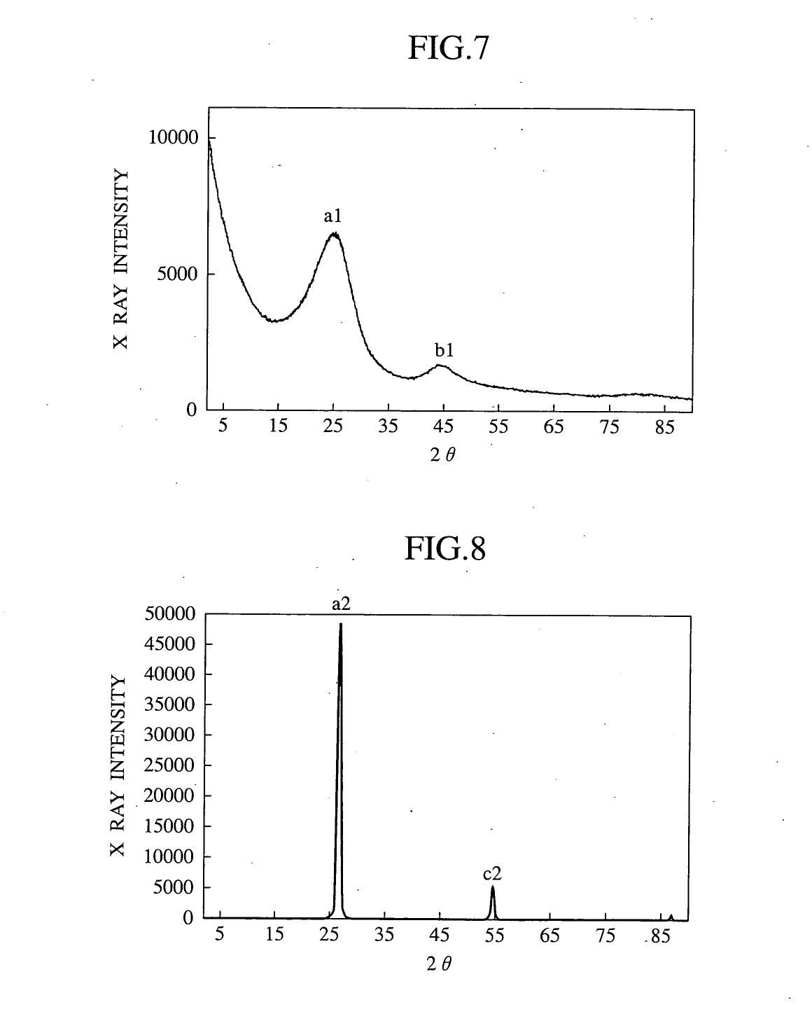

Next, the X-ray diffraction pattern obtained by XRD in Example 1 is shown in FIG. 7. In the XRD of the hydrogen storage material obtained, the (002) diffraction peak, which is an index of the size of crystallite and the degree of disorder or regularity of the crystal structure, was observed as diffraction peak a1 having a very broad peak form. The (004) diffraction peak, which is an index of the degree of disorder or regularity of the crystal structure, had a further broader peak form and hence, it was difficult to identify that as a peak (see b1).

In addition, the X-ray diffraction pattern obtained by XRD in Comparative Example 3 is shown in FIG. 8. In the XRD analysis of the hydrogen storage material obtained, (002) diffraction peak a2 was observed as a very sharp peak wherein the (002) diffraction peak is a characteristic peak in the graphite structure. From this result, it has been found that a graphite structure is formed in the hydrogen storage material obtained in Comparative Example 3. Further, the (004) diffraction peak was clearly observed (see c2).

From the above results, it has been found that the X-ray diffraction pattern obtained by XRD in Example 1 is clearly different from that in Comparative Example 3.

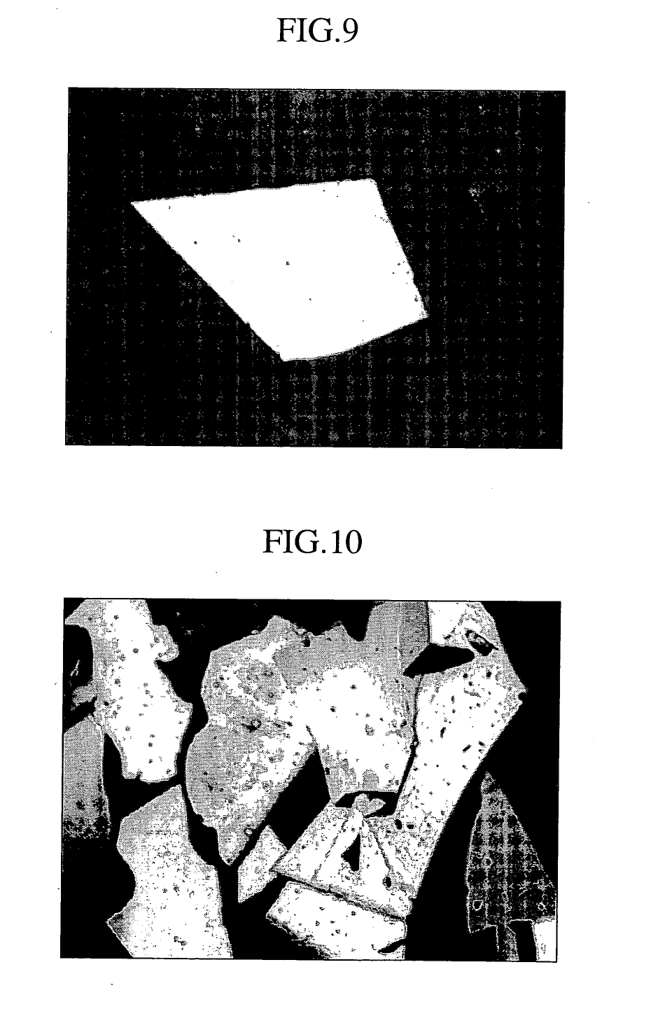

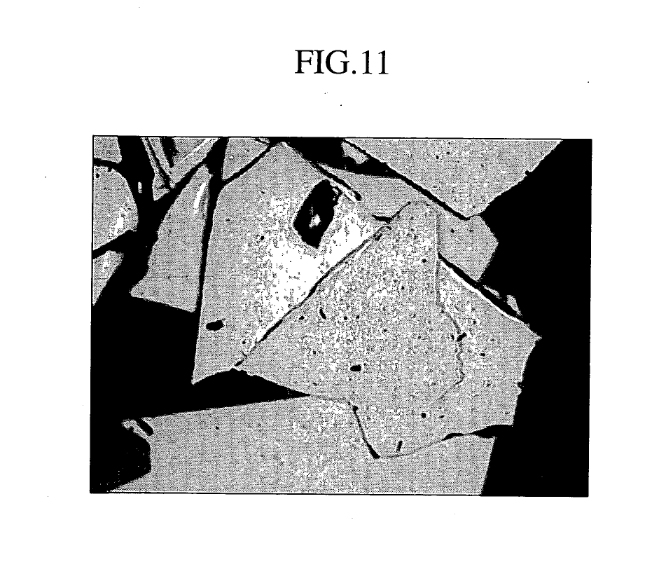

Next, the results of examination of the hydrogen storage material obtained in Example 6 under a microscope (magnification: 250) are shown in FIGS. 9 to 11. It has been found that the hydrogen storage material obtained in Example 6 is fine powder in an angular flake form as shown in FIGS. 9 to 11.

As apparent from the above results, by the method for producing a hydrogen storage material, which includes subjecting an organic polymer material to heat treatment, wherein the heat treatment is stopped before crystallization of graphite is completed, there can be realized a method for producing a hydrogen storage material having high hydrogen storage capacity.

The entire contents of a Japanese Patent Applications No. P2003-163905 with a filing date of Jun. 9, 2003 and No. P2003-350487 with a filing date of Oct. 9, 2003 are herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A hydrogen storage material, comprising:
graphite formed of graphene,
wherein the orientation of crystal planes of the graphene is disordered.

2. The hydrogen storage material of claim 1,
wherein a half peak width of a (002) diffraction peak ascribed to the graphite is within a range from 6.50 to 8.62°, as measured by X-ray diffraction method using copper as a radiation source.

3. The hydrogen storage material of claim 2,
wherein the half peak width of the (002) diffraction peak is within a range from 6.50 to 7.78°.

4. The hydrogen storage material of claim 1,
wherein the hydrogen storage material is in a flake form, and
the ratio of the maximum length in top and back flat portions to the thickness of the hydrogen storage material is within a range from 5 to 350.

5. A method for producing a hydrogen storage material, comprising:
subjecting an organic polymer material to heat treatment,
wherein the heat treatment is stopped when the orientation of crystal planes of graphene constituting the hydrogen storage material is disordered.

6. The method for producing a hydrogen storage material of claim 5,
wherein the heat treatment is conducted at a temperature of 500 to 1000°C.

7. The method for producing a hydrogen storage material of claim 5,
wherein the heat treatment is conducted in an inert gas.

8. The method for producing a hydrogen storage material of claim 5,
wherein the organic polymer material is polyacrylonitrile or polyimide.

9. The method for producing a hydrogen storage material of claim 8,
wherein the polyimide used as the organic polymer material is processed into a thin film form.

10. The method for producing a hydrogen storage material of claim 9,
wherein the hydrogen storage material obtained is in a flake form, and
the ratio of the maximum length in top and back flat portions to the thickness of the hydrogen storage material is within a range from 5 to 350.

11. A hydrogen storage apparatus, comprising:
a hydrogen storage material including graphite formed of graphene,
wherein the orientation of crystal planes of the graphene is disordered.

12. The hydrogen storage apparatus of claim 11,
wherein the hydrogen storage material is contained in a high-pressure resistant container.

13. A hydrogen storage system, comprising:
a hydrogen storage apparatus including a hydrogen storage material having graphite formed of graphene,
wherein the orientation of crystal planes of the graphene is disordered.

14. A fuel cell vehicle, comprising:
A hydrogen storage system containing a hydrogen storage apparatus including a hydrogen storage material having graphite formed of graphene,
wherein the orientation of crystal planes of the graphene is disordered.
